(19) United States
(12) Patent Application Publication
(10) Pub. No.: US 2012/0215793 A1
(43) Pub. Date: Aug. 23, 2012

(54) METHOD AND SYSTEM FOR MATCHING SEGMENT PROFILES TO A DEVICE IDENTIFIED BY A PRIVACY-COMPLIANT IDENTIFIER

(75) Inventors: Nicolas Arsenault, Montreal (CA); Marc Tremblay, Montreal (CA); Éric Mélin, Montreal (CA)

(73) Assignee: NEURALITIC SYSTEMS, Montreal (CA)

(21) Appl. No.: 13/369,014

(22) Filed: Feb. 8, 2012

Related U.S. Application Data
(60) Provisional application No. 61/440,593, filed on Feb. 8, 2011.

(51) Int. Cl. G06F 17/30

(52) U.S. Cl. 707/749; 707/736

(57) ABSTRACT

The present relates to a method and system for matching segment profiles to a device identified by a privacy-compliant identifier. For doing so, the present method and system records at least one segment profile consisting of at least one criterion. The method and system allocates a unique segment identifier to the at least one segment profile. The method and system generates in real time a correlation between each specific segment profile and devices matching the at least one criterion of the specific segment profile. The method and system receives a query with a privacy-compliant identifier corresponding to a specific device; and sends a response with at least one matching segment identifier corresponding to at least one matching segment profile. For each of the at least one matching segment profile, the specific device identified by the privacy-compliant identifier matches the at least one criterion of the matching segment profile.

### TECHNICAL FIELD

The present relates to the field of targeted content delivery based on end-user profiles; and more particularly to the usage of a privacy-compliant identifier for this purpose.

### BACKGROUND

Nowadays, the usage of various types of communication devices to access a multitude of Internet services over various types of IP based network infrastructures is growing exponentially. The communication devices include fixed (e.g. desktop), mobile (e.g. cellular phone), and nomadic (e.g. laptop) devices. The various types of IP based network infrastructures include mobile networks and fixed broadband networks. And the Internet services include, among others: web browsing, emailing, instant messaging, video and audio streaming, social networking, on-line gaming, etc. These Internet services are provided by different types of content providers, depending on the type of Internet service and the type of content delivered to the end users.

In this ecosystem, where more and more content is available, and more and more frequently for free, there is a need for stakeholders like the content providers and the network operators, to find new business models to monetize their assets. One way to do this is via the delivery of targeted content, for instance targeted advertising. The delivery of targeted content is based on the generation of profiles of end users consuming Internet services via their communication devices. The profile of an end user is representative of his preferences and usage behaviors. Being able to deliver a targeted content to the communication device of an end user, based on its profile, has more value than delivering a non-targeted content.

However, one important issue with targeted content delivery based on the generation of profiles, is privacy. The entity which generates the profiles has access to private information related to the end users, generally including unique identifiers of the end users or/and of the communication devices that they use (e.g. a phone number). It is usually not considered acceptable, from a privacy perspective, that a targeted content provider has access to the private information related to an end user. This private information is generally used in the process of matching a specific end user profile with a specific targeted content, for further delivery of the targeted content to the communication device owned by the end user.

Therefore, there is a need for overcoming the above discussed limitations concerning the respect of privacy of end users, in the context of targeted content delivery based on end user profiles.

### SUMMARY

The present disclosure relates to a method and system for matching segment profiles to a device identified by a privacy-compliant identifier. For doing so, the present method and system records at least one segment profile consisting of at least one criterion. The method and system allocates a unique segment identifier to the at least one segment profile. The method and system generates in real time a correlation between each specific segment profile and devices matching the at least one criterion of the specific segment profile. The method and system receives a query with a privacy-compliant identifier corresponding to a specific device; and sends a response with at least one matching segment identifier corresponding to at least one matching segment profile. For each of the at least one matching segment profile, the specific device identified by the privacy-compliant identifier matches the at least one criterion of the matching segment profile.

### BRIEF DESCRIPTION OF THE DRAWINGS

In the appended drawings:

FIG. 1 illustrates a system for matching segment profiles to a device identified by a privacy-compliant identifier, according to a non-restrictive illustrative embodiment;

FIG. 2 illustrates a method for matching segment profiles to a device identified by a privacy-compliant identifier, according to a non-restrictive illustrative embodiment;

FIG. 3 illustrates a profile generator for matching segment profiles to a device identified by a privacy-compliant identifier, according to a non-restrictive illustrative embodiment;

FIG. 4 illustrates an implementation of the present method and system in the context of a targeted advertising infrastructure, according to a non-restrictive illustrative embodiment.

### DETAILED DESCRIPTION

In a general embodiment, the present method is adapted for matching segment profiles to a device identified by a privacy-compliant identifier. For doing so, the method records at a profile generator at least one segment profile consisting of at least one criterion. The method allocates a unique segment identifier to the at least one segment profile. Then, the method generates in real time, at the profile generator, a correlation between each specific segment profile and devices matching the at least one criterion of the specific segment profile. Further, the method queries the profile generator with a privacy-compliant identifier corresponding to a specific device, and receives in response at least one matching segment identifier corresponding to at least one matching segment profile. For each of the at least one matching segment profile, the specific device identified by the privacy-compliant identifier matches the at least one criterion of the matching segment profile.

In another general embodiment, the present system is adapted for matching segment profiles to a device identified by a privacy-compliant identifier. For doing so, the system comprises a segment profiles unit, for recording at least one segment profile consisting of at least one criterion; and for allocating a unique segment identifier to the at least one segment profile. The system also comprises an analytic engine, for generating in real time a correlation between each specific segment profile and devices matching the at least one criterion of the specific segment profile. And the system comprises a correlations unit, for receiving a query with a privacy-compliant identifier corresponding to a specific device; and for sending a response with at least one matching segment identifier corresponding to at least one matching segment profile. For each of the at least one matching segment profile, the specific device identified by the privacy-compliant identifier matches the at least one criterion of the matching segment profile.

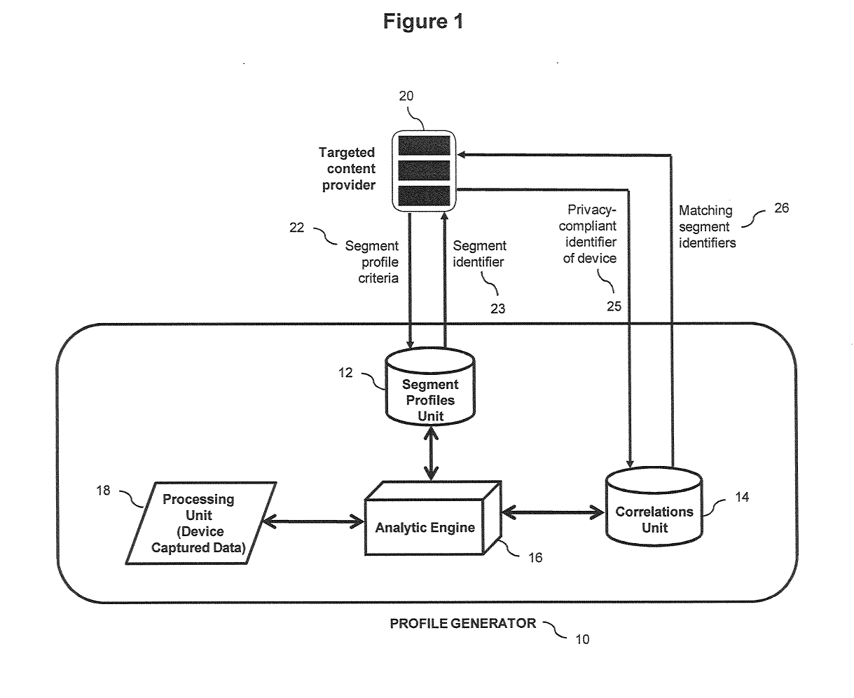

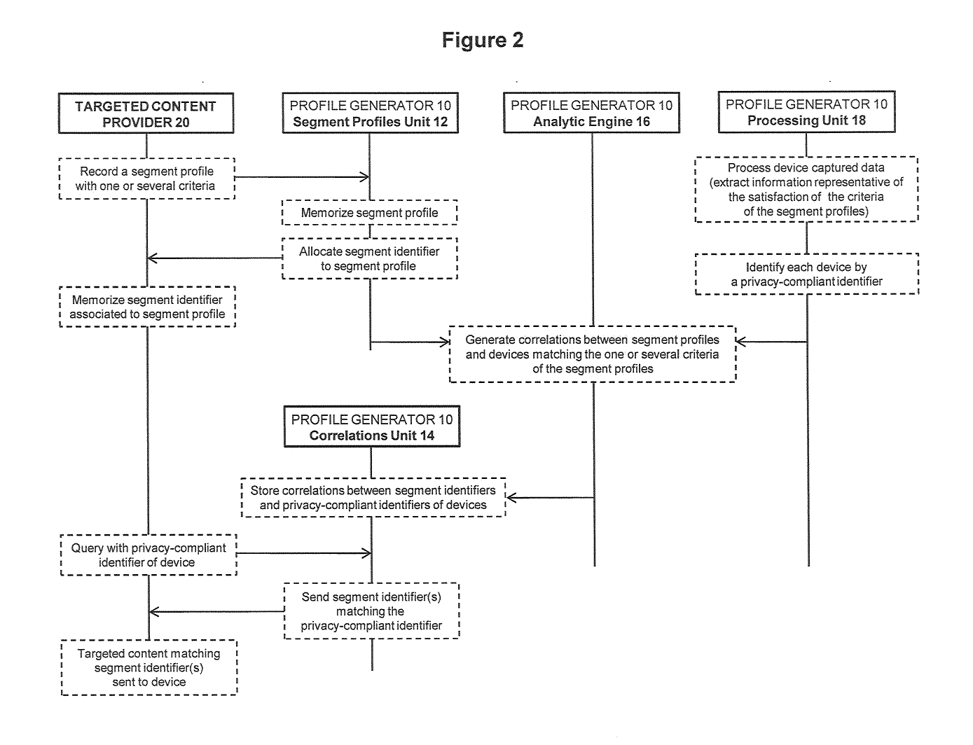

Now referring concurrently to FIGS. 1 and 2, a method and system for matching segment profiles to a device identified by a privacy-compliant identifier will be described.

A profile generator 10 is represented in FIG. 1. The profile generator 10 matches at least one segment profile to a device identified by a privacy-compliant identifier. This matching is used to select a most relevant targeted content to be delivered to the device.

In one exemplary embodiment of the present method and system, the profile generator 10 is composed of: a segment profiles unit 12, a correlations unit 14, an analytic engine 16, and a processing unit 18 (for processing device data).

The segment profiles unit 12 records all the segment profiles that have been registered by one or several targeted content provider(s) 20. A segment profile consists in at least one criterion. A criterion is related to the consumption of Internet services by a device, and to the content delivered via these Internet services. Examples of such Internet services include, without limitations: web browsing services, emailing services, instant messaging services, audio or video streaming services, social media services, Internet Protocol television (IPTV) services, on-line gaming services, etc. For instance, a web browsing service generally involves the delivery of a combination of several contents in the form of a combination of texts, images, and possibly audio and/or video content. An audio or video streaming service mainly involves the delivery of audio or video content respectively.

More specifically, examples of such criterion include: a condition related to a specific Internet service, a condition related to a specific content delivered via an Internet service, a condition related to the number of occurrences of a specific event, etc. For instance, a criterion may consist in: a specific Uniformed Resource Locator (URL) of a web site accessed by the device, a specific URL for the referrer of a web site accessed by the device, a specific key word for a search performed by the device (e.g. search via Google), a frequency of occurrence of a specific criterion (e.g. three searches related to a specific key word occurred over a one day time period).

In a specific embodiment of the present method and system, one or several criteria are combined to generate one or several rules, in order to evaluate the matching of a specific device with a segment profile corresponding to the one or several criteria.

Following is an example of a segment profile with three criteria: the device accessed the web site with URL url_{—}1 AND the referrer URL was url_{—}2 (criterion 1), the device performed a google search with key words key_word_{—}1 AND key_word_{—}2 (criterion 2), the frequency of occurrence of criteria 1 and criteria 2 is 3 times per day (criterion 3). The segment profile may be represented as a set of rules in a pre-defined format. The one or several criteria of a segment profile 22, defined by a targeted content provider 20, are registered with the segment profiles unit 12, using the pre-defined format. For instance, the following self-explanatory format may be used, with reference to the previous example: (URL url_{—}1 AND REFERRER url_{—}2 AND OCCURRENCE DAY 3) AND (SEARCH www.google.ca KEYWORD (key_word_{—}1 AND key_word_{—}2) AND OCCURRENCE DAY 3). Alternatively, an occurrence of 2 times in one hour is represented as follows: OCCURRENCE HOUR 2. Alternatively, a different occurrence may be applied to each criteria (or group of criteria) as follows: (URL url_{—}1 AND REFERRER url_{—}2 AND OCCURRENCE DAY 3) AND (SEARCH www.google.ca KEYWORD (key_word_{—}1 AND key_word_{—}2) AND OCCURRENCE HOUR 2). Extensible Markup Language (XML) format may also be used to represent the criteria defining the segment profiles.

Upon reception of the segment profile criteria 22 (representing a specific segment profile generated by a targeted content provider 20), the segment profiles unit 12 first checks the validity of the segment profile criteria 22. As previously mentioned, a segment profile may be represented by a set of rules (each rule including a single criterion or a group of criteria) in a pre-defined format. This pre-defined format is representative of the capabilities (and limitations) of the profile generator 10, with respect to the mapping of segment profiles with devices consuming Internet services and related contents. If the set of rules representing the segment profile criteria 22 is not compliant with the pre-defined format, the segment profile is not memorized, and an error is returned to the targeted content provider 20.

If the set of rules representing the segment profile criteria 22 is compliant with the pre-defined format, the segment profile criteria 22 are deemed valid, and memorized by the segment profiles unit 12. A unique segment identifier 23 is generated by the segments profiles unit 12, and allocated to the segment profile, in order to uniquely identify this specific segment profile. The unique segment identifier 23 is returned to the targeted content provider 20.

A segment profile can also be suppressed from the segment profiles unit 12, via a suppress command (not represented in FIGS. 1 and 2). The suppress command indicates the segment identifier of the segment profile to suppress. In this case, the suppressed segment profile is erased from the segment profiles unit 12, and thus no longer taken into consideration by the analytic engine 16.

Alternatively, the targeted content provider 20 may be in charge of the allocation of the unique segment identifier 23. The unique segment identifier 23 is then transmitted, along with the corresponding segment profile criteria 22, from the targeted content provider 20 to the segment profiles unit 12. However, in the case where several different targeted content providers 20 interface with the segment profiles unit 12 of a single profile generator 10, the uniqueness of the segment identifier 23 is more easily assured by the centralized profile generator 10.

The analytic engine 16 generates, in real time, a correlation between each specific segment profile stored in the segment profiles unit 12, and devices matching the at least one criterion of the specific segment profile.

For this purpose, the processing unit 18 processes device data, representative of the consumption of Internet services, and of the content delivered via these Internet services. The device data are aggregated per device. Each device is identified by a privacy-compliant identifier present in the device data. For each device, the processing unit extracts information from the aggregated data. This information is representative of the at least one criteria of a specific segment profile, for each specific segment profile present in the segment profiles unit 12.

For a specific device identified by its privacy-compliant identifier, the analytic engine 16 analyses the information extracted by the processing unit 18, and determines if the criteria of a segment profile stored in the segment profiles unit 12 are met. This analysis is repeated for each segment profile stored in the segment profiles unit 12, and for each device for which information is available from the processing unit 18.

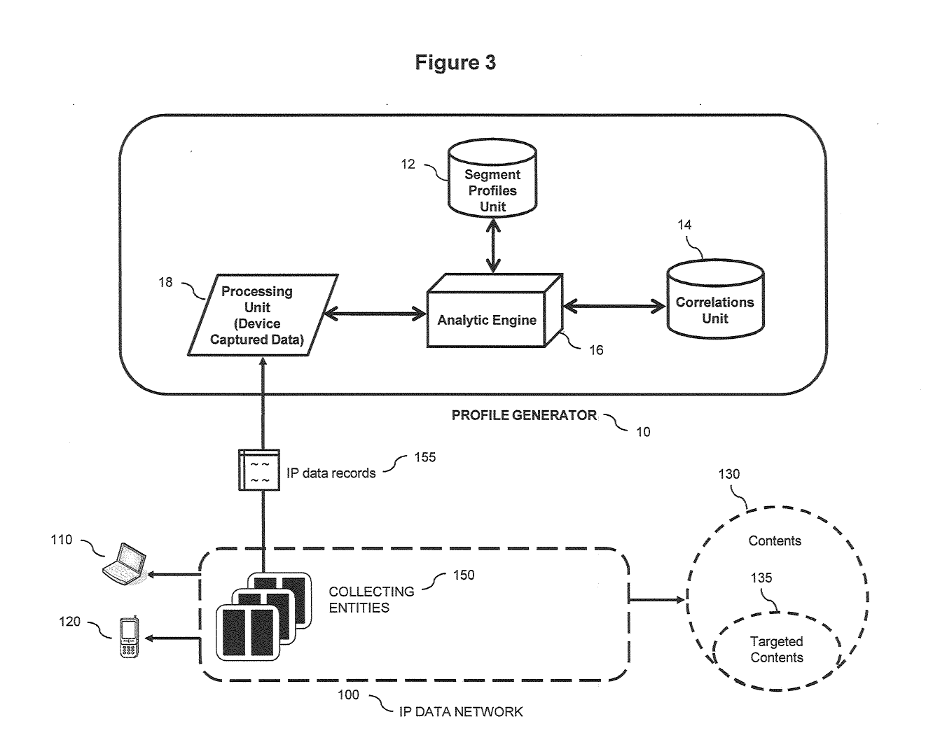

The operational mode of the processing unit 18, and of the analytic engine 16, will be further detailed later, in relation to FIG. 3.

When the analytic engine 16 determines that a specific device meets the criteria of a specific segment profile, a correlation is stored in the correlations unit 14. More specifically, a correlation between the privacy-compliant identifier of the device and the segment identifier of the segment profile is stored in the correlations unit 14.

The correlations stored in the correlations unit 14 are updated in real time. When new information extracted from the device data is available at the processing unit 18, this information is analyzed by the analytic engine 16, to update the correlations accordingly. The new information may consist in information representative of the at least one criterion of a segment profile, in a relation to a specific device. Alternatively, the new information may consist in an updated privacy-compliant identifier associated to a specific device, in the case where the privacy-compliant identifiers allocated to the devices are temporary (and change over time).

From an implementation perspective, the correlations stored in the correlation unit 14 may take several forms. For instance, a correlation may be represented by an association between a privacy-compliant identifier, and all the matching segment identifiers. Alternatively, a correlation may be represented by an association between a segment identifier, and all the privacy-compliant identifiers matching this segment identifier.

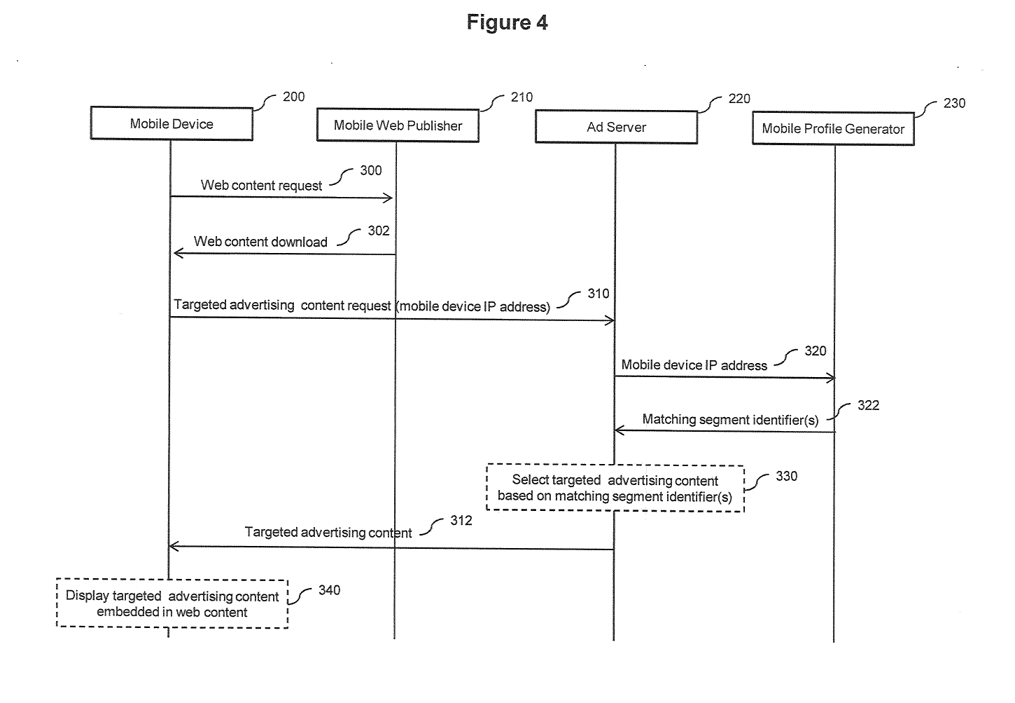

After recording at least one segment profile 22 with the segment profiles unit 12, and obtaining at least one unique segment identifier 23 corresponding to the at least one recorded segment profile, a targeted content provider 20 may query the correlations unit 14. One assumption is that the targeted content provider 20 knows the privacy-compliant identifiers associated to the devices. This assumption will be further detailed later, in relation to FIG. 4 (when the targeted content provider is an advertising server).

The targeted content provider 20 queries the correlations unit 14, with a privacy compliant identifier 25 corresponding to a specific device. The targeted content provider 20 receives in response, from the correlations unit 14, at least one matching segment identifier 26. A matching segment identifier 26 corresponds to a matching segment profile, for which the specific device identified by the privacy-compliant identifier matches the at least one criterion of the matching segment profile. The correlation between the privacy-compliant identifier and the matching segment identifiers is generated and updated in real time, by the analytic engine 16, as previously mentioned.

Upon reception of the at least one matching segment identifier 26 corresponding to the at least one matching segment profile, a targeted content is delivered to the specific device. The targeted content is associated to the at least one matching segment identifier. The targeted content is delivered to the specific device (identified by its privacy-compliant identifier 25), by the targeted content provider 20.

For illustration purposes, we assume that the targeted content provider 20 has several instances of targeted content to be delivered to devices. For each instance of a targeted content, a segment profile is created, with criteria representing the type of targeted content. The segment profiles with their criteria 22 are recorded at the segment profiles unit 12, as explained previously. A unique segment identifier 23 is allocated to each recorded segment profile, and associated to the corresponding targeted content. Then, at a precise occurrence of time, the targeted content provider 20 has an opportunity to deliver a targeted content to a specific device. The targeted content provider 20 queries the correlation units 14 with the privacy-compliant identifier 25 of the specific device. The correlations unit 14 responds with the matching segment identifiers 26. There may be zero, one, or several matching segment identifiers at the current occurrence of time. The targeted content provider 20 selects one or several instances of targeted content to deliver to the specific device, corresponding to the matching segment identifiers 26 (if any).

In an alternative embodiment, the correlations unit 14 is queried with a privacy-compliant identifier 25 corresponding to a specific device and a segment identifier corresponding to a specific segment profile (not represented in FIG. 1). The correlations unit 14 responds with an indication (true of false—not represented in FIG. 1) that the specific device identified by the privacy-compliant identifier 25 matches the at least one criterion of the specific segment profile identified by the segment identifier.

The targeted content includes one of the following: a text, an image, a video content, an audio content, or a combination thereof.

For instance, the targeted content is a targeted advertising content. In this case, the targeted content provider 20 is split in two entities. First, one or several advertising agencies perform the recording of the segment profiles 22 with the segment profiles unit 12. An advertising agency has the expertise to determine the at least one criterion of a segment profile corresponding to a specific targeted advertising content. For example, a targeted advertising content promoting a car manufacturer, or a specific model of car from a car manufacturer, corresponds to a segment profile with particular criteria (visit web sites in relation to car manufacturers and models of cars, use search engines with keywords related to car manufacturers and models of cars). An advertising agency generates the targeted advertising contents, creates the segment profiles corresponding to the different targeted advertising contents, records the segment profiles 22 with the segment profiles unit 12, and memorizes the corresponding segment identifiers 23.

Then, an advertising server queries the correlations unit 14 with the privacy-compliant identifier 25 of a specific device, and delivers targeted advertising content to the specific device. The targeted content corresponds to one or several matching segment identifiers 26 returned by the correlations unit 14.

Some synchronization between the advertising agencies and the advertising server is necessary. The advertising agencies provide the targeted advertising contents, with the segment identifier(s) corresponding to each of the targeted advertising content, to the advertising server. This use case of targeted advertising content delivery will be further detailed later, in relation to FIG. 4.

Alternatively, the targeted content provider 20 is a content provider. It adapts at least a portion of the content distributed to a device, to the interests and preferences of the owner of the device. For instance, the content provider 20 operates a web portal with different themes (e.g. sports, finance, fashion, media, finance, politics, etc). The content proposed on one or several dynamic web pages of the web portal is adapted to a specific device, using the present method and system. For each theme, a segment profile with appropriate criteria is generated. The segment profiles 22 are recorded by the content provider 20 in the segment profiles unit 12. When a device accesses a dynamic web page of the web portal, the content provider 20 queries the correlations unit 14 with the privacy-compliant identifier of the device 25. The correlations unit 14 returns one or several matching segment identifiers 26. And the content provider 20 generates a dynamic web page with one or several themes corresponding to the segment identifiers. And the dynamic web page is delivered to the device.

Another example of a content provider who may benefit from the present method and system is a provider of Internet Protocol Television (IPTV) and/or Video On Demand (VOD) contents. The IPTV and/or VOD contents are associated to appropriate segment profiles (e.g. sports, news, drama, action, etc). Criteria representative of the interest for a specific segment profile are generated for each segment profile. The interactions of the provider of IPTV and/or VOD contents 20 with the profile generator 10 are the same as for the content provider operating a web portal. The provider of IPTV and/or VOD contents uses the matching segment identifiers 26 to propose IPTV and/or VOD contents corresponding to the interests (as expressed in the segment profile criteria 22) of the owner of a device identified by its privacy-compliant identifier 25.

The previous examples (web portal, IPTV, and OVD) only constitute illustrations of how a targeted content provider 20 may use the present method and system. It may also apply to other types of targeted content providers 20 delivering other types of contents.

In an additional embodiment of the present method and system, the analytic engine 16 generates a relevance score for each correlation between a specific segment profile and a specific device matching the at least one criteria of the specific segment profile. For instance, a score of 100% means that all criteria of a segment profile have been met exactly. A score below 100% means that one or several criteria have not been met (or only partially). And a score above 100% means that all criteria have been met, with one or several criteria being satisfied beyond the defined level. The scores are also memorized in the correlations unit 14.

For instance, we consider the aforementioned example of criteria associated to a segment profile, expressed via the following rule: (URL url_{—}1 AND REFERRER url_{—}2 AND OCCURRENCE DAY 3) AND (SEARCH www.google.ca KEY_WORD (key_word_{—}1 AND key_word_{—}2) AND OCCURRENCE HOUR 2). If the sub-rule (URL url_{—}1 AND REFERRER url_{—}2) occurred exactly 3 times in the considered day, and the sub-rule (SEARCH www.google.ca KEY_WORD (key_word_{—}1 AND key_word_{—}2)) occurred exactly 2 times in the considered hour, the relevance score is 100%. If only either one of the two sub-rules (URL url_{—}1 AND REFERRER url_{—}2 AND OCCURRENCE DAY 3) or (SEARCH www.google.ca. KEY_WORD (key_word_{—}1 AND key_word_{—}2) AND OCCURRENCE HOUR 2) is satisfied, the relevance score is 50%. And if the sub-rule (URL url_{—}1 AND REFERRER url_{—}2) occurred 6 times (instead of the exact 3 times) in the considered day, while the sub-rule (SEARCH www.google.ca KEY_WORD (key_word_{—}1 AND key_word_{—}2) occurred exactly 2 times in the considered hour, the relevance score is 150%. This only constitutes an example of how the relevance score may be calculated. Any other appropriate way of calculating a relevance score is applicable in the context of the present method and system.

For each matching segment identifier 26 returned by the correlations unit 14, a relevance score associated to the corresponding matching segment profile is also returned. The targeted content (to be delivered to a device identified by its privacy-compliant identifier 25) is selected based on the relevance scores associated to the matching segment profiles corresponding to the returned matching segment identifiers 26. More specifically, the targeted content corresponding to the segment profile with the highest relevance score is selected for delivery to the device. Alternatively, N (more than one) targeted contents corresponding to the N segment profiles with the highest relevance scores are selected for delivery to the device.

In another embodiment of the present method and system, the privacy-compliant identifier of a device 25 is the IP address currently allocated to the device. This identifier is practical for several reasons. First, it is usually considered as privacy-compliant, since it is usually not easy to associate the IP address allocated to a device, with the person who owns the device. This is particularly true when the IP address allocated to a device is temporary, and changes over time. In this case, it is even more difficult to track the identity of the owner of the device using the temporary IP address allocated to this device. Secondly, the IP address allocated to the device is usually easily known by the targeted content provider 20, and by the processing unit 18. This will be further detailed later, in relation to FIG. 3.

The targeted content provider 20, as previously described in relation to FIGS. 1 and 2, only constitutes an example of an entity which can make usage of the functionalities provided by the present method and system. Any other entity capable of interfacing with the profile generator 10 (specifically with the segment profiles unit 12 and the correlations unit 14), may make usage of the functionalities provided by the present method and system.

Now referring to FIG. 3, a profile generator for matching segment profiles to a device identified by a privacy-compliant identifier will be described.

The profile generator 10 represented in FIG. 3 (as well as its sub-components: segment profiles unit 12, correlations unit 14, analytic engine 16, processing unit 18) is similar to the one represented in FIG. 1. We will now describe the operational modes of the processing unit 18 and the analytic engine 16. More specifically, we will describe how these two entities process data extracted from an IP data network 100, to evaluate the matching of a device (110 and 120) with the criteria of a segment profile (stored in the segment profiles unit 12).

An Internet Protocol (IP) data network 100 is represented in FIG. 3. It allows various devices (110 and 120) to access various types of contents 130, via the IP data network 100. In the context of the present method and system, a content 130 consists in various media supports, including texts, images, audios, videos, etc; and combinations thereof. A content 130 is delivered to a device (110 and 120), over the IP data network 100, via an Internet service (not represented in FIG. 3). An Internet service consists in any type of application or service using the Internet Protocol for data transmission. Examples of such Internet services include (as previously mentioned): web browsing services, emailing services, instant messaging services, audio or video streaming services, social media services, Internet Protocol television (IPTV) services, on-line gaming services, etc.

The present method and system is applicable to any type of mobile IP network (as an illustration of the IP data network 100), including without limitation: General Packet Radio Service (GPRS), Universal Mobile Telecommunication System (UMTS) network, Long Term Evolution (LTE) network, Code Division Multiple Access (CDMA) network, or Worldwide Interoperability for Microwave Access (WIMAX) network.

The present method and system is also applicable to any type of fixed broadband IP network (as an illustration of the IP data network 100), including without limitation: Digital Subscriber Line (DSL) networks, cable networks, or optical fiber networks

The present method and system is also applicable to an IP data network 100 operated by a corporation, for example a private company or a governmental/public organization.

Various types of devices (110 and 120) may be used to access the contents 130 via the IP data network 100. Such devices include computers 110 in their broad sense (desktops, laptops, netbooks, etc). Such devices also include mobile devices 120 in their broad sense (feature phones, smart phones, tablets, etc). Such devices may also include televisions, video game consoles, etc. Based on the underlying access technology (mobile, fixed broadband, etc) of a specific IP data network 100, only a subset of the previously mentioned types of devices may be used. However, due to the convergence of the IP data networks 100 (specifically fixed and mobile convergence), more and more types of devices may be used to seamlessly access various types of IP data networks 100.

A fraction of the contents 130 delivered to the devices (110 and 120) consist in targeted contents 135. For instance, targeted advertising contents are an illustration of targeted contents 135. Since a large amount of the contents 130 available via various types of Internet services are free, the delivery of collateral targeted advertising is a way for a content provider (not represented in FIG. 3) to earn money, while still providing most of the contents 130 for free to the end users (represented by their devices 110 and 120). In this context, the standard contents 130 delivered by the content provider are bundled with targeted advertising contents 135. The content provider relies on an advertising server (not represented in FIG. 3), to select the best targeted advertising contents 135 to deliver. This selection is based on a matching between a specific type of advertising content, and the habits/preferences of the owner of a device (110 and 130). The advertising server interacts with the profile generator 10 (specifically with the segment profiles unit 12 and with the correlations unit 14), as previously described with reference to FIGS. 1 and 2. This interaction is followed by the selection of a targeted advertising content corresponding to a segment identifier. The segment identifier identifies a specific segment profile. This segment profile has been matched with the device (identified by its privacy-compliant identifier) by the analytic engine 16. This matching is based on segment profile criteria, representative of the interest of the owner of the device for this specific segment profile. A use case involving a content provider and an advertising server will be further detailed later, in relation to FIG. 4.

Several collecting entities 150 are represented in FIG. 3. The role of the collecting entities 150 is to collect data related to the IP traffic on the IP data network 100, to extract information from the collected data, and to use this information to generate IP data records 155. Generally speaking, such an IP data record 155 is representative of an instance of an usage by an end user (represented by its device 110 or 120) of an Internet service (not represented in FIG. 3) over the IP data network 100. The usage of the Internet service involves the delivery of various contents 130. The IP data records 155 are transmitted from the collecting entities 150 to the processing unit 18 of the profile generator 10. The role of the processing unit 18 is to further process the transmitted IP data records 155, as will be further detailed later in the description.

A standard embodiment of the collecting entities 150 will now be described. First of all, the notion of an instance of an usage by an end user (represented by its device 110 or 120) of an Internet service over the IP data network 100 will be clarified. An instance of an usage is defined by the execution of an application on the device 110 or 120, the application allowing an interaction of the end user who owns the device 110 or 120 with the Internet service (not represented in FIG. 3) via the IP data network 100 (and the delivery of subsequent contents 130 to the device 110 or 120). Consequently, such an instance of an usage generates a flow of IP packets on the IP data network 100. This flow of IP packets is collected by a collecting entity 150, and identified as an instance of an usage of the Internet service. The instance is considered as terminated when the application on the device is terminated. From a networking perspective, a collecting entity 150 detects the end of an instance of an usage in two ways. First, a specific protocol sequence is detected, which is representative of the termination of the application on the device 110 or 120. Alternatively, a period of inactivity (no IP packets exchanged for a pre-defined duration) for the considered instance is also representative of the end of the instance of an usage of the Internet service. Examples of instances of an usage of an Internet service include: browsing through a web site, sending an email, receiving an email, watching a streamed video, etc. The exact definition of an instance is particular to each type of application allowing an interaction with an Internet service.

In a standard embodiment, the collecting entities 150 collect data by capturing in real time IP packets from the IP traffic occurring on a specific segment of the IP data network 100. The captured IP packets contain data related to IP sessions occurring on the IP data network 100. An IP session is defined as an IP based data session initiated by a device (110 or 120) on the IP data network 100, during which the device (110 or 120) consumes various types of Internet services (for example web browsing, emailing, multimedia streaming, etc). The IP packets related to a specific IP session are analyzed according to the protocol layers of the Open System Interconnection (OSI) model, to extract information representative of various instances of an usage by an end user (represented by its device 110 or 120) of an Internet service over the IP data network 100.

This standard embodiment of the collecting entities 150 is well known in the art as Deep Packet Inspection (DPI). And the type of parameters which can be extracted from IP packets by DPI based collecting entities 150 is also well known in the art. Considering a specific content 130 delivered to a device (110 or 120) via an Internet service (not represented in FIG. 3), a collecting entity 150 has the capability to extract the following information: the IP address of the device, a unique identifier of the device or of the owner of the device, an identifier of the Internet service, specific parameters representative of the Internet service and of the associated specific content, and a timestamp of occurrence.

For illustration purposes, we consider a web browsing session on a web site. A DPI based collecting entity 150 analyses the IP packets related to the web browsing session, and determines that the HTTP protocol is used for web browsing. It further extracts parameters including the URL of the web site, the URL of the referrer of the web site, etc. Additionally, the web site may be identified as providing a specific service, for instance Google search, in which case the search key words are also extracted.

In an exemplary embodiment where the IP data network is an UMTS cellular network, the collecting entities 150 may be positioned between a Serving GPRS Support Node (SGSN) and a Gateway GPRS Support Node (GGSN), in order to collect the IP traffic between these two equipments. This IP traffic is well known in the art as the GPRS Tunneling Protocol (GTP) control and user planes. A unique identifier of the device or of the owner of the device is extracted from the IP packets of the GTP control plane: the International Mobile Equipment Identity (IMEI), or the International Mobile Subscriber Identity (IMSI), or the Mobile Station ISDN number (MSISDN). The IP address allocated to the device is also extracted from the GTP control plane. The identifier of the Internet service (Internet protocol(s) used and/or application name), specific parameters representative of the Internet service and of the associated content, are extracted from the IP packets of the GTP user plane. The IP address allocated to the device is also extracted from the GTP user plane. The IP address allocated to the device is used to correlate the information extracted from the control and user planes.

The information extracted by the collecting entities 150, representative of the delivery of a content 130 to a device (110 or 120) via an Internet service (not represented in FIG. 3), is recorded in a pre-defined data structure: the IP data records 155. At regular intervals, the collecting entities 150 transmit the IP data records 155 to the processing unit 18 of the profile generator 10, for further processing. The IP data records 155 contain all the information collected by the collecting entities 150 over a pre-defined period of time.

Usually, several collecting entities 150 (as represented in FIG. 3) are deployed, to monitor various segments of the IP data network 100. The number of collecting entities 150, and their precise location, is dependent on the technology, topology, and size, of the IP data network 100. For example, in the case of an UMTS cellular network, one collecting entity 150 may be deployed per GGSN.

The processing unit 18 processes the information present in the IP data records 155 (this information is also referred to as the device data). The device data are aggregated per device, and each device is identified by the unique identifier of the device (or of the owner of the device).

The privacy-compliant identifier of the device is extracted/generated for each device present in the IP data records 155. In most cases, the unique identifier of the device (or of the owner of the device) is different from the privacy-compliant identifier of the device. For instance, the privacy-compliant identifier may be a temporary identifier, which changes over time, like the IP address of the device. On the contrary, the unique identifier of the device (or of the owner of the device) is a permanent identifier, which does not change over time. This unique identifier serves as a reference for uniquely identifying each specific device (for example, the IMEI or the IMSI or the MSISDN in the case of an UMTS cellular network). For privacy reasons, the unique identifier of the device is not shared between the profile generator 10, and the entities which interface with it (e.g. the targeted content provider 20 in FIG. 1).

For each device, the processing unit 18 extracts information from the aggregated device data. This information is representative of the at least one criteria of each segment profile present in the segment profiles unit 12. A timestamp of occurrence is also associated to the information. The information, along with the timestamp of occurrence, is stored in a database (not represented in FIG. 3). The information currently present in the database (based on the processing of the previously received IP data records), is updated with the information based on the processing of the currently received IP data records.

For instance, the information includes the URLs of the web sites visited by the devices, the referrer URLs of the web sites visited by the devices, the key words of the searches performed by the devices via Google search or via thematic search platforms (e.g. a search engine on a web portal dedicated to cars).

From an implementation perspective, it may be too resource consuming to store all the extracted information (for example, all the URLs, all the referrer URLs, and all the search key words). Thus, the analytic engine 16 may communicate to the processing unit 18, which specific type of information is pertinent, based on the criteria of each segment profile stored in the segment profiles unit 12. For example, the analytic engine 18 may communicate the specific URLs and referrer URLs present in the criteria, and the specific key words present in the criteria. Additionally, a rule engine may be implemented at the processing unit 18, to efficiently determine whether the specific type of information communicated by the analytic engine 16 is present in the device data. Then, only occurrences of the specific type of information communicated by the analytic engine 16, along with a timestamp of occurrence, are stored in the database.

The analytic engine 16 is the central entity of the profile generator 10. It takes into account (in real time) any evolution of the data managed by the segment profiles unit 12 and the processing unit 18, to re-evaluate the matching between the segment profiles and the devices. Following the re-evaluation, it automatically updates the correlations unit 14 (suppress any expired matching, add any new matching). The interactions of the analytic engine 16 with the segment profiles unit 12 and the correlations unit 14 have already been described, in relation to FIGS. 1 and 2.

When a new set of IP data records 155 has been received and processed by the processing unit 18, the analytic engine 16 immediately analyses the information extracted by the processing unit 18 (from the currently and previously received IP data records 155) for each device. It determines if the at least one criterion of a segment profile stored in the segment profiles unit 12 are met. This analysis is repeated for each segment profile stored in the segment profiles unit 12, and for each device for which information is available from the processing unit 18. The analytic engine 16 also determines if the privacy-compliant identifier of a device has changed (this may be the case for temporary allocated IP addresses). The same analysis is also performed by the analytic engine 16, when a new segment profile has just been added to the segment profiles unit 12. As mentioned previously, following this analysis, the correlation units 14 is updated, with the updated list of matching segment profiles/devices. And with the updated privacy-compliant identifiers of the devices when necessary.

For instance, we consider the aforementioned example of criteria associated to a segment profile, expressed via the following rule: (URL url_{—}1 AND REFERRER url_{—}2 AND OCCURRENCE DAY 3) AND (SEARCH www.google.ca KEY WORD (key_word_1 AND key_word_{—}2) AND OCCURRENCE HOUR 2). For each device, the processing unit 18 memorizes the following information (extracted from the IP data records 155): each occurrence of an access to the web site with URL url_{—}1 and referrer URL url_{—}2, along with the timestamp of occurrence; each occurrence of a search on the web site www.google.ca with key words key_word_{—}1 and key_word_{—}2, along with the timestamp of occurrence. For each device, the analytic engine 16 analyzes the information memorized by the processing unit 18, using the timestamps to identify a simultaneous occurrence of the sub-rule (URL url_{—}1 AND REFERRER url_{—}2) tree times within the same day. And of the sub-rule (SEARCH www.google.ca KEY WORD (key_word_{—}1 AND key_word_{—}2)) two times within the same hour. Such a simultaneous occurrence constitutes a matching between the device and the segment profile associated to this rule.

Although the analytic engine 16, the processing unit 18, and the collecting entities 150, have been represented as standalone functional entities in an illustrative embodiment of the present method and system, they may be partly or entirely combined in one or several alternative functional entities, without changing the scope of the present method and system.

Now referring to FIG. 4, an implementation of the present method and system in the context of a targeted advertising infrastructure will be described.

For illustration purposes, we consider a mobile network infrastructure. A mobile device 200 (corresponding to device 120 in FIG. 3) is accessing a web content (corresponding to contents 130 in FIG. 3) via the mobile IP network infrastructure (corresponding to the IP data network 100 in FIG. 3). A mobile web publisher 210 operates a web portal, hosting the web content that is accessed by the mobile device 200.

The mobile device 200 sends a web content request 300 to the mobile web publisher 210 (via the HTTP protocol), to retrieve a specific web page of the web portal of the web publisher 210. The web content of the specific web page is downloaded 302 by the mobile device 200 from the mobile web publisher portal 210.

The mobile web publisher 210 has an agreement with an ad server 220 (corresponding to the targeted content provider 20 in FIG. 1). Various targeted advertising contents (corresponding to the targeted contents 135 in FIG. 3) are embedded by the ad server 220, in the web content delivered by the mobile web publisher 210.

Thus, we consider that the downloaded web content 302 includes an indication that a targeted advertising content must be retrieved from the ad server 220. For this purpose, the mobile device 200 sends a targeted advertising content request 310 to the ad server 220. The source IP address of this request is the IP address of the mobile device 200. The ad server 220 queries a mobile profile generator 230 (corresponding to the profile generator 10 of FIG. 1) with the mobile device IP address 320 (corresponding to the privacy-compliant identifier 25 of the device in FIG. 1).

The mobile profile generator 230 answers with one or several matching segment identifier(s) 322 (corresponding to the matching segment identifiers 26 of FIG. 1). The ad server 220 selects 330 a targeted advertising content based on the matching segment identifier(s) 322. The step involving the registration of the segment profile criteria with the mobile profile generator 230 by a targeted content provider (the ad server 220 of FIG. 4 or an advertising agency not represented in FIG. 4) has not been represented in FIG. 4 for simplification purposes, but has already been detailed in relation to FIGS. 1 and 2.

For each specific segment profile identified by a segment profile identifier, and registered with the mobile profile generator 230, the ad server 220 has one or several targeted advertising content(s) corresponding to the thematic of this specific segment profile. It is out of the scope of the present method and system to determine which specific targeted advertising content is selected 330, among those corresponding to the matching segment identifier 322 (it is part of the internal mechanisms and strategies of an ad server 220).

Then, the ad server 220 sends the selected targeted advertising content 312 to the mobile device 200. And the mobile device 200 displays 340 the targeted advertising content 312 embedded in the downloaded web content 302 (a web browser on the mobile device performs the display).

Coming back to FIG. 1, an additional embodiment of the present method and system will be described. The targeted content provider 20 is granted the capability to benchmark segment profile criteria with the profile generator 10. For this purpose, a new interface is created between the targeted content provider 20 and the profile generator 10. Via this new interface, the targeted content provider 20 submits a segment profile with tentative criteria, and a reference period of time over which the criteria shall be evaluated. The targeted content provider 20 receives in response a number of matching devices over the reference period of time. The number of matching devices may be further refined in: the total number of matching devices, and the number of unique matching devices (the same matching device is counted only once over the reference period of time). Additionally, the number of matching devices can be calculated over sub-periods of the reference period of time. For example, if the reference period of time is a week, the total number of matching devices can be calculated for each day of the week (and for each hour of each day of the week).

The analytic engine 16 and the processing unit 18 are adapted to support this additional functionality of the profile generator 10. The processing unit 18 memorizes the information extracted from the device data (the IP data records 155 in FIG. 3) over a longer period of time (for instance several weeks or several months); instead of a few hours or a few days when the profile generator 10 operates in real time, as previously described in relation to FIGS. 1, 2, and 3. As already mentioned, the memorized information is aggregated per device, and is representative of the various criteria registered in the segment profiles unit 12. The analytic engine 16 analyzes the historical information memorized by the processing unit 18, for a reference period of time and for the criteria of a segment profile to be benchmarked. The resulting number of matching devices is returned to the targeted content provider 20.

The segment profiles unit 12, the correlations unit 14, the analytic engine 16, and the processing unit 18, are respectively composed of dedicated software programs executed on dedicated computers. Alternatively, dedicated software programs corresponding to any combinations of the segment profiles unit 12, the correlations unit 14, the analytic engine 16, and the processing unit 18, may be executed on the same computer. Additionally, the aforementioned entities (12, 14, 16, and 18) also include some data storage capacity when applicable, for instance a database.

Although the present method and system have been described in the foregoing description by way of illustrative embodiments thereof, these embodiments can be modified at will, within the scope of the appended claims without departing from the spirit and nature of the appended claims.

1. A method for matching segment profiles to a device identified by a privacy-compliant identifier, the method comprising:
recording at a profile generator at least one segment profile consisting of at least one criterion;
allocating a unique segment identifier to the at least one segment profile;
generating in real time at the profile generator a correlation between each specific segment profile and devices matching the at least one criterion of the specific segment profile;
querying the profile generator with a privacy-compliant identifier corresponding to a specific device, and receiving in response at least one matching segment identifier corresponding to at least one matching segment profile; wherein for each of the at least one matching segment profile, the specific device identified by the privacy-compliant identifier matches the at least one criterion of the matching segment profile.

2. The method of claim 1, wherein the privacy-compliant identifier of a device is an IP (Internet Protocol) address currently allocated to the device.

3. The method of claim 1, wherein a criterion consists of at least one of: an URL (Uniform Resource Locator) of a web site accessed by a device, a referrer URL of a web site accessed by a device, a key word of a search performed by a device, a frequency of occurrence of a specific criterion; or a combination thereof.

4. The method of claim 1, wherein upon receiving in response the at least one matching segment identifier corresponding to at least one matching segment profile, a targeted content associated to the at least one matching segment identifier is delivered to the specific device.

5. The method of claim 4, wherein the targeted content includes one of: a text, an image, a video content, an audio content; or a combination thereof.

6. The method of claim 4, wherein the targeted content consists of one of: a targeted advertising content, a dynamic web page of a web portal, a Video On Demand (VOD) content, an Internet Protocol Television (IPTV) content, or a combination thereof.

7. The method of claim 4, wherein the profile generator generates a relevance score for each correlation between a specific segment profile and a specific device matching the at least one criterion of the specific segment profile.

8. The method of claim 7, wherein upon receiving in response several matching segment identifiers, the targeted content is selected based on the relevance scores of the several matching segment profiles corresponding to the several matching segment identifiers.

9. The method of claim 1, wherein the profile generator is queried with a privacy-compliant identifier corresponding to a specific device and a segment identifier corresponding to a specific segment profile; and responds with an indication that the specific device identified by the privacy-compliant identifier matches the at least one criterion of the specific segment profile identified by the segment identifier.

10. The method of claim 1, wherein generating in real time at the profile generator a correlation between each specific segment profile and the devices matching the at least one criterion of the specific segment profile consists in:
receiving IP data records representative of an IP data traffic generated by a specific device, the IP data records including the privacy-compliant identifier of the specific device;
processing the IP data records to extract information representative of the at least one criterion of the specific segment profile;
analyzing the extracted information to evaluate the matching by the specific device of the at least one criterion of the specific segment profile;
memorizing a correlation between the specific segment profile and the specific device when the matching of the at least one criterion is satisfied; the correlation consisting in mapping the privacy-compliant identifier of the specific device to the segment identifier of the specific segment profile.

11. A profile generator system for matching segment profiles to a device identified by a privacy-compliant identifier, the system comprising:
a segment profiles unit for:
recording at least one segment profile consisting of at least one criterion,
allocating a unique segment identifier to the at least one segment profile;
an analytic engine for:
generating in real time a correlation between each specific segment profile and devices matching the at least one criterion of the specific segment profile; and
a correlations unit for:
receiving a query with a privacy-compliant identifier corresponding to a specific device, sending a response with at least one matching segment
identifier corresponding to at least one matching segment profile; wherein for each of the at least one matching segment profile, the specific device identified by the privacy-compliant identifier matches the at least one criterion of the matching segment profile.

12. The system of claim 11, wherein the privacy-compliant identifier of a device is an IP (Internet Protocol) address currently allocated to the device.

13. The system of claim 11, wherein a criterion consists of at least one of: an URL of a web site accessed by a device, a referrer URL of a web site accessed by a device, a key word of a search performed by a device, a frequency of occurrence of a specific criterion; or a combination thereof.

14. The system of claim 11, wherein upon receiving a response form the correlations unit with the at least one matching segment identifier corresponding to at least one matching segment profile, a targeted content associated to the at least one matching segment identifier is delivered to the specific device.

15. The system of claim 14, wherein the targeted content includes one of: a text, an image, a video content, an audio content; or a combination thereof.

16. The system of claim 14, wherein the targeted content consists of one of: a targeted advertising content, a dynamic web page of a web portal, a VOD content, an IPTV content, or a combination thereof.

17. The system of claim 14, wherein the analytic engine generates a relevance score for each correlation between a specific segment profile and a specific device matching the at least one criterion of the specific segment profile.

18. The system of claim 17, wherein upon receiving a response form the correlations unit with several matching segment identifiers, the targeted content is selected based on the relevance scores of the several matching segment profiles corresponding to the several matching segment identifiers.

19. The system of claim 11, wherein the correlations unit receives a query with a privacy-compliant identifier corresponding to a specific device and a segment identifier corresponding to a specific segment profile; and sends a response with an indication that the specific device identified by the privacy-compliant identifier matches the at least one criterion of the specific segment profile identified by the segment identifier.

20. The system of claim 11, wherein a processing unit:
receives IP data records representative of an IP data traffic generated by a specific device, the IP data records including the privacy-compliant identifier of the specific device,
processes the IP data records to extract information representative of the at least one criterion of a specific segment profile,
memorizes the extracted information representative of the at least one criterion of the specific segment profile;
the analytic engine:
analyzes the memorized information to evaluate the matching by the specific device of the at least one criterion of the specific segment profile; and
the correlation units:
memorizes a correlation between the specific segment profile and the specific device when the matching of the at least one criterion is satisfied; the correlation consisting in mapping the privacy-compliant identifier of the specific device to the segment identifier of the specific segment profile.
